(19) United States
(12) Patent Application Publication
(10) Pub. No.: US 2026/0036939 A1
(43) Pub. Date: Feb. 5, 2026

(54) SHEET CONVEYANCE APPARATUS

(71) Applicant: CANON KABUSHIKI KAISHA, Tokyo (JP)

(72) Inventor: SO MATSUMOTO, Saitama (JP)

(21) Appl. No.: 19/276,600

(22) Filed: Jul. 22, 2025

(30) Foreign Application Priority Data
Aug. 2, 2024 (JP) 2024-128067

(51) Int. Cl. G03G 21/16; G03G 15/00

(52) U.S. Cl. CPC G03G 21/1638; G03G 15/6502; G03G 21/1647; G03G 2221/1687

(57) ABSTRACT

A sheet conveyance apparatus includes an apparatus main body including a guide member that forms a conveyance path, and a door portion openable and closable and including a first pivot member pivoting around a first pivot shaft and a second pivot member coupled to the first pivot member with a second pivot shaft parallel to the first pivot shaft and pivoting around the second pivot shaft, wherein the second pivot member forms, with the guide member, a conveyance path through which the sheet passes when the door portion is closed, wherein, when the door portion is opened, the first pivot member pivots around the first pivot shaft, and the second pivot member, with the pivoting of the first pivot member, pivots around the second pivot shaft with respect to the first pivot shaft so that a leading end of the second pivot member approaches the first pivot shaft.

### BACKGROUND

### Field of the Technology

The present disclosure relates to a sheet conveyance apparatus that conveys a sheet.

### Description of the Related Art

Japanese Patent Application Laid-Open No. 2020-117317 discusses an image forming apparatus including a jam recovery door that is provided in an apparatus main body so as to be capable of being opened and closed, and an external sheet feeding unit mounted on the image forming apparatus. A swing guide is attached to the jam recovery door, and constitutes part of a guide that forms a vertical path and a lateral path. When the jam recovery door is opened, the swing guide is separated from the apparatus main body and also pivots with respect to the jam recovery door, and the vertical path and the lateral path are opened.

However, the jam recovery door discussed in Japanese Patent Application Laid-Open No. 2020-117317 is disposed to face the external sheet feeding unit mounted on the image forming apparatus, and it is necessary to separate the external sheet feeding unit from the image forming apparatus to open the jam recovery door. The external sheet feeding unit is a heavy object that accommodates a large number of sheets, and moving the external sheet feeding unit to perform jam recovery has been a factor for decreasing maintainability.

### SUMMARY

The present disclosure is directed to provision of a sheet conveyance apparatus that saves space for opening and closing a door portion and that enhances maintainability.

According to some embodiments, a sheet conveyance apparatus configured to convey a sheet includes an apparatus main body including a guide member that forms a conveyance path, and a door portion that is capable of being opened and closed with respect to the apparatus main body, the door portion including a first pivot member that is supported so as to be capable of pivoting around a first pivot shaft with respect to the apparatus main body, and a second pivot member that is coupled to the first pivot member with a second pivot shaft that is parallel to the first pivot shaft and that is supported so as to be capable of pivoting around the second pivot shaft, wherein the second pivot member forms, together with the guide member, a conveyance path through which the sheet passes in a state where the door portion is closed with respect to the apparatus main body, wherein, when the door portion is opened with respect to the apparatus main body, the first pivot member is configured to pivot around the first pivot shaft with respect to the apparatus main body, and the second pivot member is configured to, with the pivoting of the first pivot member, pivot around the second pivot shaft with respect to the first pivot shaft so that a leading end of the second pivot member approaches the first pivot shaft.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an overall schematic view illustrating an image forming system according to a first exemplary embodiment.

FIG. 2 is a perspective view illustrating the image forming system.

FIG. 3 is a cross-sectional view illustrating a door portion according to a comparative example.

FIG. 4 is a cross-sectional view illustrating a state where the door portion according to the comparative example is opened/closed.

FIG. 5A is a cross-sectional view illustrating a state where a door portion according to the first exemplary embodiment is closed. FIG. 5B is a cross-sectional view illustrating a state where the door portion according to the first exemplary embodiment is opened.

FIG. 6A is a perspective view illustrating a guide member. FIG. 6B is a cross-sectional view illustrating a configuration of positioning the guide member.

FIG. 7A is a perspective view illustrating a hook in the door portion. FIG. 7B is a cross-sectional view illustrating a configuration of positioning a second pivot member of the door portion.

FIG. 8A is a cross-sectional view illustrating a state where the door portion is closed. FIG. 8B is a cross-sectional view illustrating a state where the door portion is being opened. FIG. 8C is a cross-sectional view illustrating a state where the door portion is opened.

FIG. 9 is a cross-sectional view illustrating a stopper according to a second exemplary embodiment.

### DESCRIPTION OF THE EMBODIMENTS

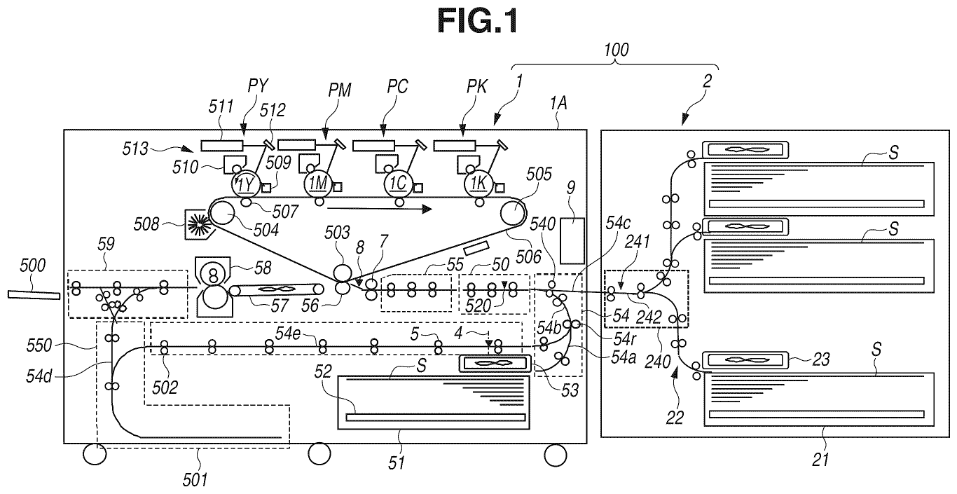

A first exemplary embodiment of the present disclosure will be described in detail with reference to drawings. As illustrated in FIG. 1, an image forming system 100 includes an image forming apparatus 1 as a sheet conveyance apparatus, and a sheet feeding apparatus 2. Examples of the image forming apparatus 1 include a printer, a copy machine, a facsimile, and a multi-functional peripheral. The image forming apparatus 1 forms an image on a sheet used as a recording medium based on image information input from an external personal computer (PC) or image information read from a document. In the present exemplary embodiment, an electrophotographic full-color laser printer is employed as the image forming apparatus 1. The electrophotographic full-color laser printer is employed as the image forming apparatus 1 according to the present exemplary embodiment, but, for example, an image forming apparatus including an image forming means using an ink-jet system instead of an electrophotography system may be employed.

### Outline of Image Forming Apparatus

The image forming apparatus 1 is, for example, a print on demand (POD) machine that supports print for an application purpose other than office work, and in the image forming apparatus 1, various sheets, such as paper, paper for an envelope or the like, glossy paper, a plastic film including an overhead projector (OHP) sheet, or a cloth can be used as a recording medium. An apparatus main body 1A of the image forming apparatus 1 houses a feeding cassette 51 that accommodates a sheet S and an image forming unit 513 that forms an image on the sheet S fed from the feeding cassette 51. The image forming unit 513 employs a tandem intermediate transfer system and includes four process units PY, PM, PC, and PK that form respective toner images in yellow, magenta, cyan, and black, and an intermediate transfer belt 506, which is an intermediate transfer body. The process units PY, PM, PC, and PK are electrophotography units respectively including photosensitive drums 1Y, 1M, 1C, and 1K, which are photosensitive bodies.

Because the process units PY, PM, PC, and PK are similarly configured except a difference in color of toner used in development, a description is given of a configuration of a process unit and a toner image formation process (image forming operation) taking the yellow process unit PY as an example. The process unit PY includes, in addition to the photosensitive drum 1Y, an exposure device 511, a developing device 510, and a drum cleaner 509.

The photosensitive drum 1Y is a drum-shape photosensitive body including a photosensitive layer on its outer periphery portion, and rotates in a direction along a rotational direction of the intermediate transfer belt 506. Charges are supplied from a charging means such as a charging roller to a surface of the photosensitive drum 1Y, whereby the surface of the photosensitive drum 1Y is charged. The exposure device 511 emits laser light modulated according to image information and an optical system including a reflection device 512 scans the photosensitive drum 1Y, whereby an electrostatic-latent image is drawn on the surface of the photosensitive drum 1Y. The developing device 510 accommodates a developer containing toner, supplies toner to the photosensitive drum 1Y, and thereby develops the electrostatic latent image into a toner image. The toner image formed on the photosensitive drum 1Y is primarily transferred to the intermediate transfer belt 506 by a primary transfer roller 507. Residual toner on the photosensitive drum 1Y after transfer is removed by the drum cleaner 509.

The intermediate transfer belt 506 is wound around a driving roller 504, a driven roller 505, a secondary transfer inner roller 503, and a plurality of primary transfer rollers 507, and rotationally driven by the driving roller 504 in a clockwise direction in FIG. 1. The above-mentioned image forming operation is performed in each of the process units PY, PM, PC, and PK in parallel and four color toner images are multiple-transferred so as to be superimposed on one another, whereby a full-color toner image is formed on the intermediate transfer belt 506. This toner image is borne by the intermediate transfer belt 506 and conveyed to a secondary transfer unit. The secondary transfer unit is configured as a nip portion between a secondary transfer roller 56 and the secondary transfer inner roller 503. A bias voltage with a polarity opposite to a charging polarity of toner is applied to the secondary transfer roller 56, whereby the toner image is secondarily transferred to the sheet S. That is, the secondary transfer roller 56 is an example of a transfer unit that transfers an image on the intermediate transfer belt 506 to the sheet S. Residual toner on the intermediate transfer belt 506 after transfer is removed by a belt cleaner 508.

The sheet S to which the toner image has been transferred is delivered to a fixing unit 58 by a pre-fixing conveyance unit 57. The fixing unit 58 includes a fixing roller pair that nips and conveys the sheet S and a heat source such as a halogen heater, and heats and applies pressure to the toner image borne by the sheet S. As a result, toner particles are melted and solidified, and a fixed image that is fixed to the sheet S is obtained.

### Feeding System of Image Forming Apparatus

A description will be given of a configuration and operation of a sheet conveyance system that feeds the sheet S accommodated in the feeding cassette 51 and that discharges the sheet S on which an image has been formed to the outside of the image forming apparatus 1. The sheet conveyance system roughly includes a conveyance unit 54, a pre-registration conveyance unit 50, a skew correction unit 55, a registration roller pair 7, a branch conveyance unit 59, and a re-conveyance unit 550.

The feeding cassette 51 is mounted on the apparatus main body 1A so as to be capable of being pulled out, and sheets S stacked on a lifting plate 52 that can be lifted and lowered are fed one by one by a feeding unit 53. Examples of the feeding unit 53 include a belt-system feeding unit that separates the sheet S and adsorbs the sheet S onto a belt member by a suction fan (refer to FIG. 1) and a friction separation system feeding unit that uses a roller or a pad. A conveyance unit 54 is an example of a conveyance unit that forms a feeding path 54a from the feeding cassette 51 toward the image forming unit 513 and conveys a sheet on the feeding path 54a. The sheet S sent out from the feeding unit 53 is conveyed along the feeding path 54a by a conveyance roller pair 54r in the conveyance unit 54 and delivered to the pre-registration conveyance unit 50.

The pre-registration conveyance unit 50 includes, for example, three conveyance roller pairs, each of which sends out the sheet S in a sheet conveyance direction. A sheet sensor 520 that detects a leading end of the sheet S is disposed in the pre-registration conveyance unit 50. That is, the sheet sensor 520 is disposed on the feeding path 54a between the feeding cassette 51 and the skew correction unit 55, and detects the sheet S conveyed on the feeding path 54a. As the sheet sensor 520, it is possible to use, for example, a reflection-type photoelectronic sensor including a light-emitting unit and a light-receiving unit. In this case, light emitted by the light-emitting unit is reflected by the sheet S that has reached a detection position and the reflected light is detected by the light-receiving unit, whereby a timing at which the sheet S passes is detected. Delay time of the sheet S is measured based on a detection result from the sheet sensor 520, conveyance speed of the sheet S in the pre-registration conveyance unit 50 is changed according to the delay time, the delay time is offset, and thereafter the sheet S is conveyed to the skew correction unit 55.

The skew correction unit 55 is a side registration system sheet alignment device including, for example, three skew feeding rollers and a reference member. That is, the skew correction unit 55 is disposed between the conveyance unit 54 and the image forming unit 513, and corrects skew movement of the sheet S while conveying the sheet S at conveyance speed that is lower than conveyance speed by the conveyance unit 54. The conveyance speed by the skew correction unit 55 is in step with a timing of transfer of an image by the secondary transfer roller 56. The sheet S is subjected to skew correction by the skew correction unit 55, and thereafter sent to the secondary transfer unit by the registration roller pair 7.

The sheet S, to which the toner image has been transferred in the secondary transfer unit and has been fixed by the fixing unit 58, is conveyed to the branch conveyance unit 59 including a switching member that is capable of switching a conveyance route of the sheet S. In a case where image formation on the sheet S is completed, the sheet S is discharged by a discharge roller pair to a discharge tray 500 that is disposed lateral to the apparatus main body 1A.

In a case where the sheet S is discharged to the discharge tray 500 with a lower side of the sheet S serving as a print side, the sheet S is conveyed to a reverse conveyance unit 501 once and switched back, and thereafter discharged to the discharge tray 500.

In a case where an image is formed on a back side of the sheet S, the sheet S is conveyed to the re-conveyance unit 550. The re-conveyance unit 550 includes the reverse conveyance unit 501 and a double-sided conveyance unit 502, reverses the front and back sides of the sheet S with the image having been formed by the image forming unit 513 on the front side of the sheet S, to convey the sheet S, and causes the sheet S to join a feeding path 54a between the sheet sensor 520 and the feeding cassette 51. The re-conveyance unit 550 includes a reverse path 54d, which is a reverse route for reversing the sheet conveyance direction, and a re-conveyance path 54e, which is a double-sided conveyance path. The re-conveyance path 54e causes the sheet S conveyed from the reverse path 54d to join the feeding path 54a between the sheet sensor 520 and the feeding cassette 51.

The sheet S conveyed from the branch conveyance unit 59 is delivered to the double-sided conveyance unit 502 including the re-conveyance path 54e, via the reverse conveyance unit 501 including the reverse path 54d. The reverse conveyance unit 501 includes a reverse roller pair that is capable of performing normal rotation and reverse rotation, switches back the sheet S, and delivers the sheet S to the double-sided conveyance unit 502. The leading end of the sheet S conveyed to the double-sided conveyance unit 502 is detected by a detection unit 4 that is provided on the re-conveyance path 54e and that detects the leading end of the sheet S, and the sheet S stops within the re-conveyance path 54e and stands by until the sheet S is re-fed for image formation on the second side (double-sided standby). As the detection unit 4, it is possible to employ, for example, an optical sensor similarly to the sheet sensor 520. The double-sided conveyance unit 502 conveys the sheet S to the pre-registration conveyance unit 50 in step with the timing of image formation on the second side. That is, the re-conveyance unit 550 stops the sheet S on the re-conveyance path 54e once and starts to convey the sheet S to the skew correction unit 55. After the image is formed on the back side of the sheet S, the sheet S is discharged to the discharge tray 500.

### Sheet Feeding Apparatus

As illustrated in FIG. 1, the sheet feeding apparatus 2 is connected to the image forming apparatus 1 on the upstream side of the horizontal path 54c. The sheet feeding apparatus 2 is provided with three sets, each including a feeding cassette 21 and a sheet feeding unit 23, that are aligned in a vertical direction. Each feeding cassette 21 has a configuration similar to that of the feeding cassette 51 in the image forming apparatus 1. The sheet S accommodated in each feeding cassette 21 is fed by the sheet feeding unit 23.

Similarly to the image forming apparatus 1, the sheet S is fed by the sheet feeding unit 23 in step with the timing of image formation of the image forming apparatus 1. The fed sheet S is conveyed to the horizontal unit 240 by a conveyance unit 22. The horizontal unit 240 is provided with a horizontal path 242 that extends along the horizontal direction, and the horizontal path 242 is provided with a detection unit 241 that detects the leading end of the sheet S. As the detection unit 241, it is possible to employ, for example, an optical sensor that is similar to the sheet sensor 520. When the detection unit 241 detects the leading end of the sheet S, the sheet S is stopped once. The sheet S is re-fed in step with the timing of image formation in the image forming apparatus 1 and conveyed to the image forming apparatus 1. This makes it possible to correct variations in conveyance timing in the sheet feeding unit 23. The sheet feeding unit 23 and the conveyance unit 22 in the sheet feeding apparatus 2 can be controlled by a control unit 9 in the image forming apparatus 1.

The sheet S conveyed through the horizontal path 242 is delivered to a horizontal path 54c in the image forming apparatus 1. The feeding path 54a includes a curvature path 54b in a curved shape. The curvature path 54b and the horizontal path 54c join together at a junction 540. A conveyance path from the horizontal path 242 in the sheet feeding apparatus 2 to the discharge tray 500 linearly extends in a substantially horizontal direction. This makes it possible to reduce conveyance resistance of a sheet and reduce load and damage on the sheet.

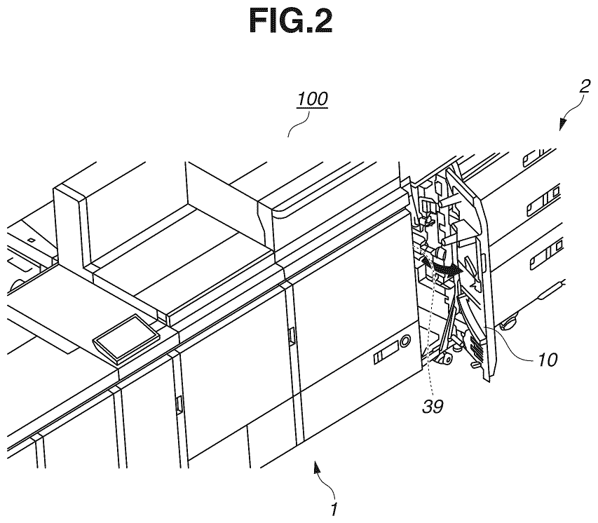

FIG. 2 is a perspective view illustrating the image forming system 100. As illustrated in FIGS. 1 and 2, in a case where the sheet S is jammed in the neighborhood of the junction 540 in the image forming apparatus 1, a user opens a front door 10 of the sheet feeding apparatus 2. The user opens a door portion 39 in the image forming apparatus 1, and can thereby perform recovery of a jam that has occurred in the neighborhood of the junction 540.

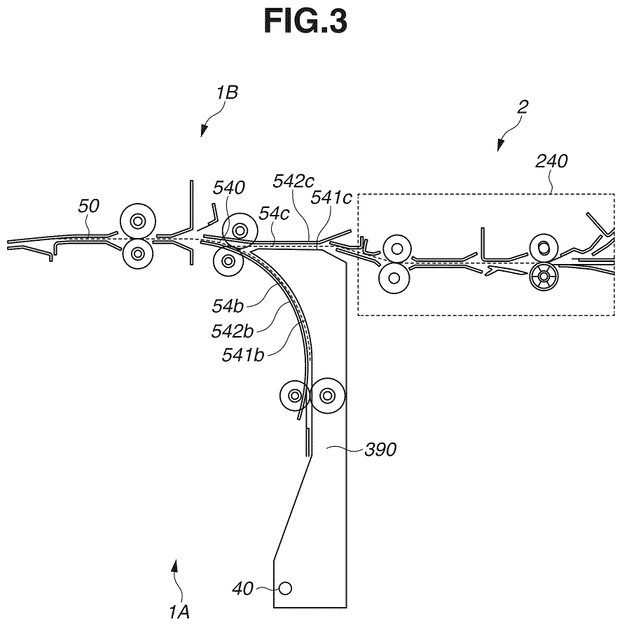

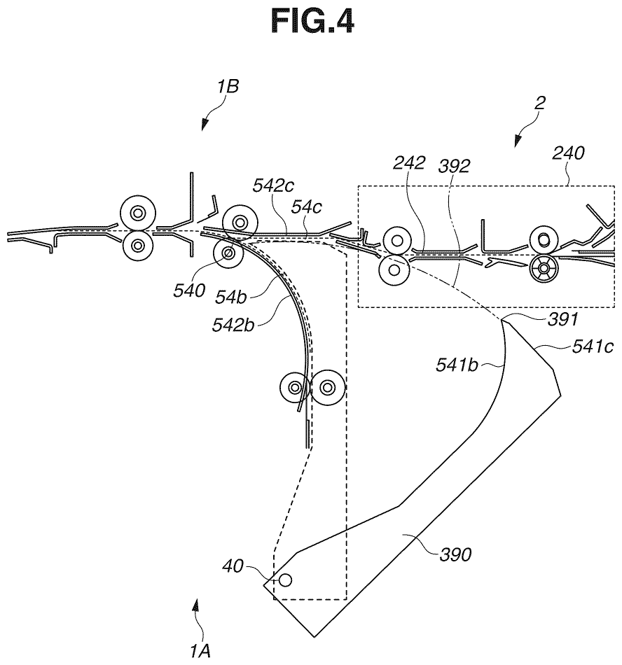

A comparative example in which the door portion 39 is composed of one opening/closing member is now described with reference to FIGS. 3 and 4. FIG. 3 is a cross-sectional view illustrating a door portion 390 according to the comparative example. FIG. 4 is a cross-sectional view illustrating a state where the door portion 390 according to the comparative example is opened/closed. As illustrated in FIG. 3, an image forming apparatus 1B according to the comparative example includes the door portion 390. The door portion 390 is disposed to face the sheet feeding apparatus 2 connected to the image forming apparatus 1.

The door portion 390 is supported so as to be capable of pivoting around a first pivot shaft 40 with respect to the apparatus main body 1A, and is configured to be capable of being opened and closed with respect to the apparatus main body 1A. The apparatus main body 1A includes guide members 542b and 542c. The door portion 390 includes a guide surface 541b facing the guide member 542b and a guide surface 541c facing the guide member 542c. In the state where the door portion 390 is closed with respect to the apparatus main body 1A, the guide surface 541b and the guide member 542b form the curvature path 54b, and the guide surface 541c and the guide member 542c form the horizontal path 54c as a second conveyance path. The horizontal path 54c extends along the horizontal direction. The curvature path 54b and the horizontal path 54c join together at the junction 540 surrounded by the guide members 542b and 542c and the door portion 390. In other words, the curvature path 54b and the horizontal path 54c join together between the guide members 542b and 542c.

In FIG. 4, a movement locus 392 of a leading end portion 391 of the door portion 390 is indicated by alternate long and double-short dashed lines when the door portion 390 is opened/closed with respect to the apparatus main body 1A. The movement locus 392 overlaps with the horizontal path 242 in a horizontal unit 240 in the sheet feeding apparatus 2 when viewed from a shaft direction of the first pivot shaft 40. That is, to open/close the door portion 390 according to the comparative example, it is necessary to perform an operation of separating the sheet feeding apparatus 2 from the image forming apparatus 1B. To address this, in the present exemplary embodiment, the door portion 39 is divided into a first pivot member and a second pivot member, and each of the first pivot member and the second pivot member is configured to pivot.

### Peripheral Configuration of Door Portion

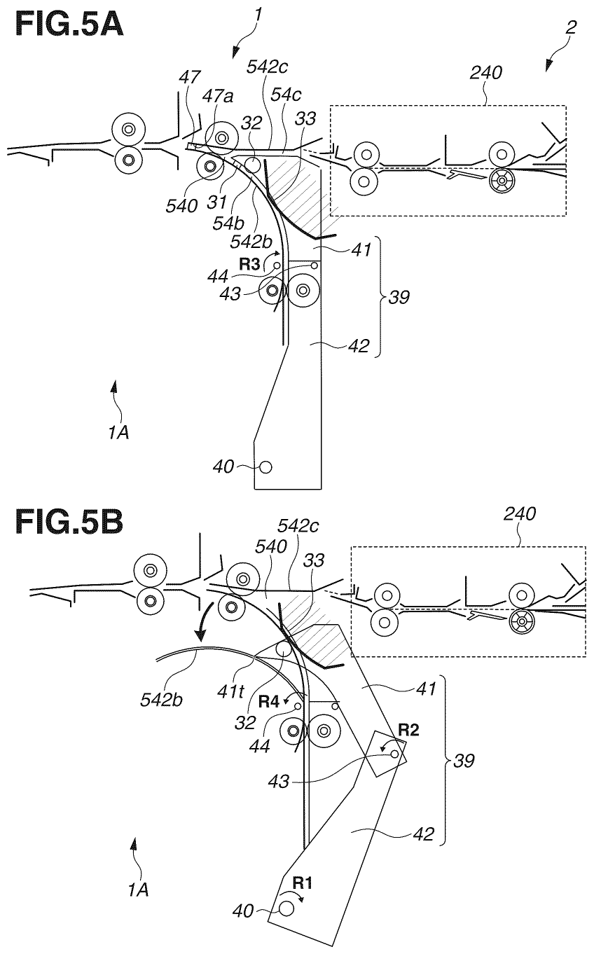

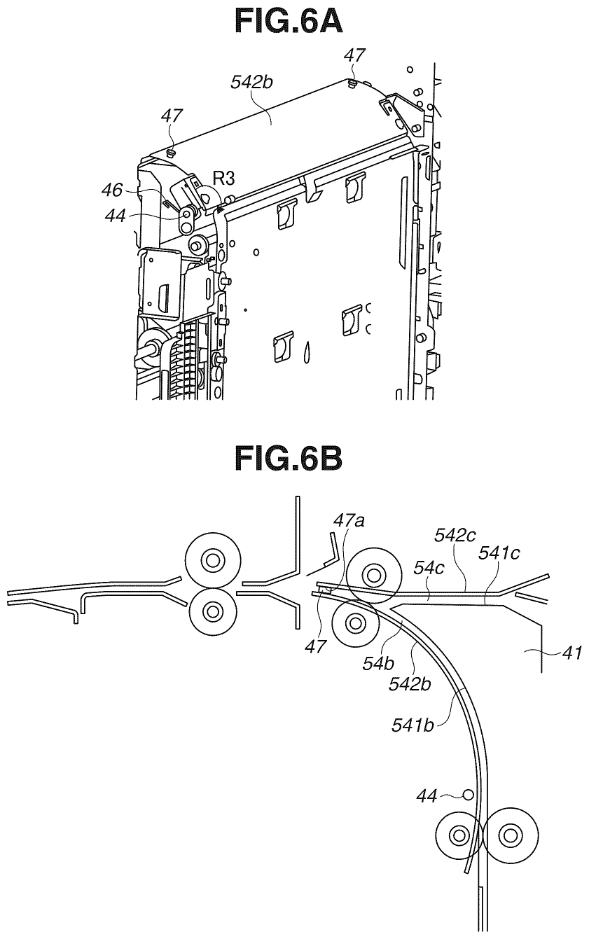

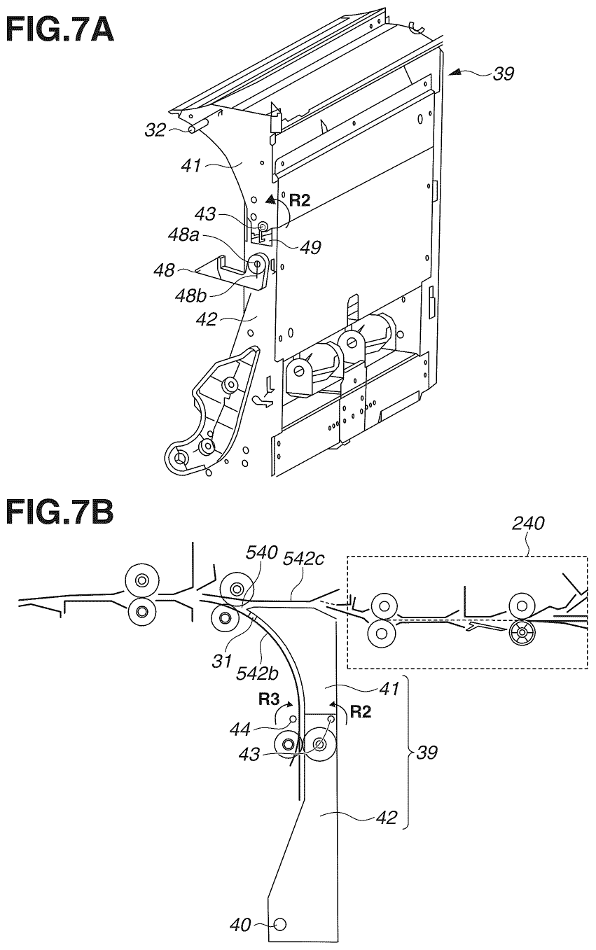

A peripheral configuration of the door portion 39 according to the present exemplary embodiment is now described with reference to FIGS. 5A, 5B, 6A, 6B, 7A, and 7B. FIG. 5A is a cross-sectional view illustrating a state where the door portion 39 according to the first exemplary embodiment is closed. FIG. 5B is a cross-sectional view illustrating a state where the door portion 39 is open. FIG. 6A is a perspective view illustrating a guide member 542b. FIG. 6B is a cross-sectional view illustrating a configuration of positioning the guide member 542b. FIG. 7A is a perspective view illustrating a hook 48 in the door portion 39. FIG. 7B is a cross-sectional view illustrating a configuration of positioning a second pivot member 41 of the door portion 39.

As illustrated in FIG. 5A, the door portion 39 according to the present exemplary embodiment includes a first pivot member 42 and a second pivot member 41. The first pivot member 42 is supported so as to be capable of pivoting around the first pivot shaft 40 with respect to the apparatus main body 1A. The second pivot member 41 is supported so as to be capable of pivoting around a second pivot shaft 43, which is parallel to the first pivot shaft 40, with respect to the first pivot member 42. The first pivot shaft 40 and the second pivot shaft 43 each extend in a sheet width direction that is orthogonal to the sheet conveyance direction of the conveyed sheet S.

The second pivot member 41 includes the guide surface 541b facing the guide member 542b as a first guide member and the guide surface 541c facing the guide member 542c as a second guide member. In the present exemplary embodiment, the guide member 542b is configured to be capable of pivoting around a third pivot shaft 44 that is parallel to the first pivot shaft 40 and the second pivot shaft 43. The guide member 542c is fixed to a frame of the apparatus main body 1A. The frame is not illustrated.

As illustrated in FIG. 6A, the guide member 542b is urged around the third pivot shaft 44 in an arrow R3 direction by a torsion coil spring 46. That is, the torsion coil spring 46 as a first urging member urges the guide member 542b in a direction to approach the second pivot member 41. A pair of protrusions 47 is provided in the leading end portion of the guide member 542b outside a sheet passing region through which the sheet S passes.

As illustrated in FIGS. 5A and 6B, the pair of protrusions 47 comes into contact with a contact portion 47a of the guide member 542c, whereby the guide member 542b is positioned at a standby position. That is, the guide member 542b is located at the standby position in the state where the door portion 39 is closed with respect to the apparatus main body 1A. The guide member 542b located at the standby position forms, together with the guide surface 541b of the second pivot member 41, the curvature path 54b. A height of the curvature path 54b in the sheet thickness direction is defined by a height of the pair of protrusions 47 provided in the guide member 542b.

As illustrated in FIG. 7A, the second pivot member 41 of the door portion 39 is urged around the second pivot shaft 43 in an arrow R2 direction, which is the opposite direction to the arrow R3 direction (refer to FIG. 7B), by a torsion coil spring 49. That is, the torsion coil spring 49 as a second urging member urges the second pivot member 41 in a direction to approach the guide member 542b. In substitution for the torsion coil springs 46 and 49, another spring member such as a plate spring or a torsion bar may be employed, or another urging member such as a rubber, a sponge, or a magnet may be employed.

As illustrated in FIG. 7B, a pair of protrusions 31 is provided in the leading end portion of the second pivot member 41 outside the sheet passing region through which the sheet S passes. The height of the curvature path 54b in the sheet thickness direction is defined by the pair of protrusions 31 in the second pivot member 41 coming into contact with the guide member 542b.

At this time, an urging force of the torsion coil spring 46 (refer to FIG. 6A) to urge the guide member 542b in the arrow R3 direction is larger than an urging force of the torsion coil spring 49 to urge the second pivot member 41 in the arrow R2 direction as a second direction. As a result, in the state where the door portion 39 is closed with respect to the apparatus main body 1A, the guide member 542b is positioned at the standby position by coming into contact with the guide member 542c, and the second pivot member 41 is positioned by coming into contact with the guide member 542b. Since the second pivot member 41 is positioned with respect to the guide member 542b in the present exemplary embodiment, it is possible to increase the accuracy of a relative position between the second pivot member 41 and the guide member 542b.

The first pivot member 42 of the door portion 39 is provided with the hook 48. The hook 48 is supported so as to be capable of pivoting around a pivot shaft 48a with respect to the first pivot member 42, and positioned by a spring 48b at a locking position illustrated in FIG. 7A. The hook 48 is engaged with a shaft attached to the frame of the apparatus main body 1A, whereby the door portion 39 is held in the state where the door portion 39 is closed with respect to the apparatus main body 1A. The shaft is not illustrated.

As illustrated in FIGS. 5A, 5B, and 7A, the apparatus main body 1A includes a guide rail 33 as a guide unit, and the second pivot member 41 of the door portion 39 includes a shaft portion 32 that is slidable on the guide rail 33. The shaft portion 32 extends in the sheet width direction. The shape of the guide rail 33 is not limited, and a pivoting locus of the second pivot member 41 is changeable depending on the shape of the guide rail 33.

### Door Portion and Operation of Guide Member

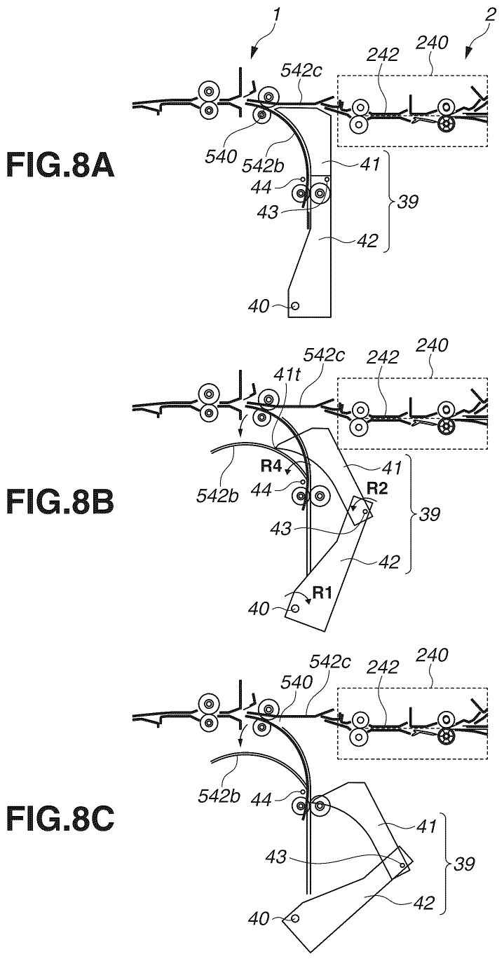

An operation of the door portion 39 and that of the guide member 542b when the door portion 39 is opened/closed with respect to the apparatus main body 1A are now described with reference to FIGS. 5A, 5B, and 8A to 8C. FIG. 8A is a cross-sectional view illustrating the state where the door portion 39 is closed. FIG. 8B is a cross-sectional view illustrating a state where the door portion 39 is being opened. FIG. 8C is a cross-sectional view illustrating the state where the door portion 39 is open.

A gripping portion connected to the hook 48 via a link mechanism is provided on an external surface of the first pivot member 42 of the door portion 39. The gripping portion is not illustrated. By gripping the gripping portion, the user can move the hook 48 from a locking position to a non-locking position, and unlock the door portion 39 with respect to the apparatus main body 1A.

By gripping the gripping portion and pulling the gripping portion toward the outside of the apparatus main body 1A, the user can open the door portion 39 with respect to the apparatus main body 1A as illustrated in FIGS. 5A and 5B. At this time, the first pivot member 42 of the door portion 39 is pulled by the user via the gripping portion, and thereby performs a first operation of pivoting around the first pivot shaft 40 in an arrow R1 direction as a first direction with respect to the apparatus main body 1A. The shaft portion 32 is pressed by the guide rail 33 when the door portion 39 is opened with respect to the apparatus main body 1A, whereby the second pivot member 41 performs a second operation of pivoting around the second pivot shaft 43 in the arrow R2 direction with respect to the first pivot member 42, as illustrated in FIGS. 5A and 5B.

At this time, as illustrated in FIGS. 5B and 8B, the guide member 542b performs a third operation of moving from the standby position in a direction away from the conveyance path and the curvature path 54b as a first conveyance path in conjunction with the above-mentioned second operation of the second pivot member 41. That is, in the third operation, the guide member 542b pivots around the third pivot shaft 44 from the standby position in a direction away from the curvature path 54b (arrow R4 direction). This is because, when the second pivot member 41 performs the above-mentioned second operation, a leading end portion 41t of the second pivot member 41 presses the guide member 542b, and causes the guide member 542b to pivot in the arrow R4 direction.

The leading end portion 41t of the second pivot member 41 presses the guide member 542b due to a tensile force applied by pulling the first pivot member 42 by the user via the gripping portion. Hence, a force of the leading end portion 41t to press the second pivot member 41 is larger than a force of the torsion coil spring 46 to urge the guide member 542b in the arrow R3 direction, which is the opposite direction to the arrow R4 direction.

Such operations of the first pivot member 42, the second pivot member 41, and the guide member 542b cause the second pivot member 41 to overlap with the standby position of the guide member 542b when viewed from the shaft direction of the second pivot shaft 43. That is, the second pivot member 41 moves while going into the inside of the apparatus main body 1A with respect to the guide member 542b located at the standby position, and it is possible to increase an amount of pivoting of the second pivot member 41 with respect to the first pivot member 42. As a result, it is possible to reduce the size of the pivoting locus of the door portion 39.

The user is able to remove a jammed sheet around the junction 540 in the state where the door portion 39 is opened with respect to the apparatus main body 1A. As illustrated in FIG. 8C, when performing jam recovery around the junction 540, the user causes the guide member 542b to pivot in the arrow R4 direction and can thereby ensure wide space for jam recovery.

Meanwhile, when closing the door portion 39 with respect to the apparatus main body 1A, the user may perform the above-mentioned procedures of opening the door portion 39 in a reverse order. That is, the user causes the first pivot member 42 to pivot in the opposite direction to the arrow R1 direction with respect to the apparatus main body 1A while gripping the gripping portion, which is not illustrated, in the door portion 39. At this time, the guide member 542b is urged by the torsion coil spring 46 in the arrow R3 direction (refer to FIG. 6A), and thereby presses the second pivot member 41 so as to press the shaft portion 32 against the guide rail 33.

Hence, with the pivoting of the first pivot member 42 in the opposite direction to the arrow R1 direction, the second pivot member 41 pivots in the opposite direction to the arrow R2 direction while the shaft portion 32 slides on the guide rail 33. The guide member 542b pivots in conjunction with the second pivot member 41. With this configuration, the door portion 39 moves in the order of FIGS. 8C, 8B, and 8A, and is held by the hook 48 with respect to the apparatus main body 1A in the state where the door portion 39 is closed with respect to the apparatus main body 1A.

As described above, in the present exemplary embodiment, the door portion 39 includes the first pivot member 42 and the second pivot member 41, each of which is capable of pivoting, and the guide member 542b that constitutes the internal guide of the curvature path 54b is also configured to be capable of pivoting. When the door portion 39 is opened/closed with respect to the apparatus main body 1A, the first pivot member 42 and the second pivot member 41 pivot in mutually opposite directions (the arrow R1 direction and the arrow R2 direction, respectively), whereby it is possible to reduce a size of the pivoting locus of the door portion 39. The guide member 542b facing the second pivot member 41 pivots in the arrow R4 direction, which is identical to the arrow R2 direction, in conjunction with the pivoting of the second pivot member 41 in the arrow R2 direction. As a result, it is possible to increase an amount of pivoting of the second pivot member 41, and reduce the size of the pivoting locus of the door portion 39.

As a result, the door portion 39 is capable of being opened and closed with respect to the apparatus main body 1A in a state where the sheet feeding apparatus 2 is connected to the image forming apparatus 1. More specifically, even if the door portion 39 is opened with respect to the apparatus main body 1A in the state where the sheet feeding apparatus 2 is connected to the image forming apparatus 1, the second pivot member 41 of the door portion 39 does not interfere with the horizontal path 242 in the sheet feeding apparatus 2. This eliminates the need for the user to separate the sheet feeding apparatus 2 from the image forming apparatus 1 when opening the door portion 39 to perform jam recovery around the junction 540 or maintenance. In this manner, it is possible to save space for opening and closing the door portion 39, and enhance maintainability, jam recovery, and usability.

A second exemplary embodiment of the present disclosure is now described. The second exemplary embodiment has a configuration of positioning the second pivot member 41 in the first exemplary embodiment with respect to a stopper 34. Hence, a constituent element that is similar to that of the first exemplary embodiment is described while illustration thereof is omitted or an identical reference sign is added thereto in the drawings.

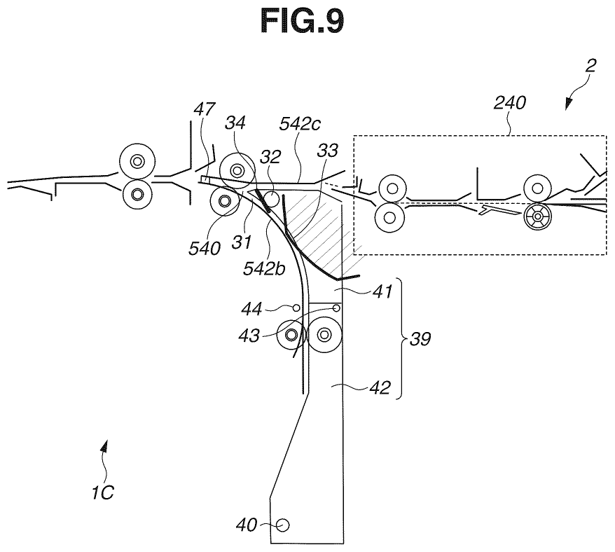

FIG. 9 is a cross-sectional view illustrating the stopper 34 according to the second exemplary embodiment. As illustrated in FIG. 9, an apparatus main body 1C according to the second exemplary embodiment includes the stopper 34 as a positioning unit that is provided separately from the guide member 542b. The shaft portion 32 of the second pivot member 41 comes into contact with the stopper 34 in a state where the door portion 39 is closed with respect to the apparatus main body 1C. That is, the second pivot member 41 is positioned with respect to the stopper 34 in the apparatus main body 1C.

In this manner, in the present exemplary embodiment, the guide member 542b facing the second pivot member 41 does not receive a force from the second pivot member 41 in the state where the door portion 39 is closed with respect to the apparatus main body 1C. Hence, even if a force is applied by the sheet S to the guide member 542b when the sheet S such as thick paper passes through the curvature path 54b, an urging force of the torsion coil spring 46 is larger than the force, which makes it hard to move the guide member 542b from the standby position.

This makes it hard for the position of the guide member 542b and that of the second pivot member 41 to fluctuate when the sheet S passes through the curvature path 54b, and makes it possible to reduce a conveyance malfunction such as a paper jam.

In each of the above-mentioned exemplary embodiments, the guide member 542b is configured to be capable of pivoting around the third pivot shaft 44, but the configuration is not limited to the example. For example, the guide member 542b may be configured to slidably move in a direction away from the curvature path 54b.

In each of the above-mentioned exemplary embodiments, the guide member 542b is configured to pivot in the arrow R4 direction by being pressed by the leading end portion 41t of the second pivot member 41, but the configuration is not limited to the example. For example, a configuration may be employed in which a link mechanism that connects the second pivot member 41 and the guide member 542b is provided and the guide member 542b pivots in conjunction with the pivoting of the second pivot member 41.

In each of the above-mentioned exemplary embodiments, the door portion 39 includes the first pivot member 42 and the second pivot member 41, but the configuration is not limited to the example. For example, the door portion 39 may include three or more pivot members.

In each of the above-mentioned exemplary embodiments, the second pivot member 41 of the door portion 39 forms both the curvature path 54b and the horizontal path 54c, but the configuration is not limited to the example. For example, the second pivot member 41 may form only one conveyance path of the curvature path 54b and the horizontal path 54c. The shape of the curvature path 54b and that of the horizontal path 54c are not limited.

In each of the above-mentioned exemplary embodiments, the guide member 542b and the door portion 39 are provided in the image forming apparatus 1, but the configuration is not limited to the example. For example, the present disclosure may be applied to another unit without the image forming unit 513, such as a finisher.

According to the present disclosure, it is possible to save space for opening and closing the door portion 39, and enhance maintainability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-128067, filed Aug. 2, 2024, which is hereby incorporated by reference herein in its entirety.

What is claimed is:

1. A sheet conveyance apparatus configured to convey a sheet, the sheet conveyance apparatus comprising:
an apparatus main body including a guide member that forms a conveyance path; and
a door portion that is capable of being opened and closed with respect to the apparatus main body, the door portion including:
a first pivot member that is supported so as to be capable of pivoting around a first pivot shaft with respect to the apparatus main body; and
a second pivot member that is coupled to the first pivot member with a second pivot shaft that is parallel to the first pivot shaft and that is supported so as to be capable of pivoting around the second pivot shaft,
wherein the second pivot member forms, together with the guide member, a conveyance path through which the sheet passes in a state where the door portion is closed with respect to the apparatus main body,
wherein, when the door portion is opened with respect to the apparatus main body, the first pivot member is configured to pivot around the first pivot shaft with respect to the apparatus main body, and the second pivot member is configured to, with the pivoting of the first pivot member, pivot around the second pivot shaft with respect to the first pivot shaft so that a leading end of the second pivot member approaches the first pivot shaft.

2. The sheet conveyance apparatus according to claim 1,
wherein, when the door portion is opened with respect to the apparatus main body, the first pivot member is configured to pivot in a first direction around the first pivot shaft with respect to the apparatus main body, and the second pivot member is configured to pivot in a second direction around the second pivot shaft with respect to the first pivot member, the second direction being an opposite direction to the first direction.

3. The sheet conveyance apparatus according to claim 1,
wherein the guide member is movably mounted on the apparatus main body,
wherein the guide member is positioned at a standby position in the state where the door portion is closed with respect to the apparatus main body, and wherein, when the door portion is opened with respect to the apparatus main body, the guide member is configured to move from the standby position in a direction away from the conveyance path in conjunction with the pivoting of the second pivot member.

4. The sheet conveyance apparatus according to claim 3, wherein, when the door portion is opened with respect to the apparatus main body, the second pivot member is configured to pivot while pressing the guide member.

5. The sheet conveyance apparatus according to claim 3, wherein, when the door portion is opened with respect to the apparatus main body, the guide member is configured to pivot from the standby position in a direction away from the conveyance path around a third pivot shaft that is parallel to the first pivot shaft and the second pivot shaft.

6. The sheet conveyance apparatus according to claim 3, wherein the apparatus main body includes a guide unit configured to guide the second pivot member when the door portion is opened with respect to the apparatus main body.

7. The sheet conveyance apparatus according to claim 3, further comprising:
a first urging member configured to urge the guide member in a direction to approach the second pivot member;
a second urging member configured to urge the second pivot member in a direction to approach the guide member; and
a contact portion configured to position the guide member at the standby position by the guide member urged by the first urging member coming into contact with the contact portion.

8. The sheet conveyance apparatus according to claim 7, wherein an urging force of the first urging member is larger than an urging force of the second urging member.

9. The sheet conveyance apparatus according to claim 7,
wherein the guide member is a first guide member and the conveyance path is a first conveyance path,
wherein the apparatus main body includes a second guide member,
wherein the second pivot member forms, together with the second guide member, a second conveyance path through which the sheet passes in the state where the door portion is closed with respect to the apparatus main body,
wherein the first conveyance path joins the second conveyance path between the first guide member and the second guide member, and
wherein the contact portion is provided in the second guide member.

10. The sheet conveyance apparatus according to claim 1,
wherein the guide member is a first guide member and the conveyance path is a first conveyance path,
wherein the apparatus main body includes a second guide member,
wherein the second pivot member forms, together with the second guide member, a second conveyance path through which the sheet passes in the state where the door portion is closed with respect to the apparatus main body, and
wherein the first conveyance path joins the second conveyance path between the first guide member and the second guide member.

11. The sheet conveyance apparatus according to claim 10, wherein, when the door portion is opened with respect to the apparatus main body, the second pivot member is configured to pivot around the second pivot shaft so as not to interfere with the second guide member.

12. The sheet conveyance apparatus according to claim 10,
wherein a sheet conveyed from a sheet feeding apparatus, which is connected to the sheet conveyance apparatus so as to face the door portion, passes through the second conveyance path, and
wherein the door portion is configured to be capable of being opened and closed with respect to the apparatus main body in the state where the sheet feeding apparatus is connected to the sheet conveyance apparatus.

13. The sheet conveyance apparatus according to claim 10,
wherein the second conveyance path extends in a horizontal direction, and
wherein the first conveyance path extends so as to be curved toward a junction between the first conveyance path and the second conveyance path.

14. The sheet conveyance apparatus according to claim 10, wherein the leading end is located at a position where the first conveyance path and the second conveyance path join together in the state where the door portion is closed with respect to the apparatus main body.

15. The sheet conveyance apparatus according to claim 1, wherein the second pivot member is positioned with respect to the guide member in the state where the door portion is closed with respect to the apparatus main body.

16. The sheet conveyance apparatus according to claim 1,
wherein the apparatus main body includes a positioning unit that is provided separately from the guide member, and
wherein the second pivot member is positioned with respect to the positioning unit in the state where the door portion is closed with respect to the apparatus main body.

17. The sheet conveyance apparatus according to claim 1, further comprising an image forming unit configured to form an image on the sheet.
